(19) United States
(12) Patent Application Publication
(10) Pub. No.: US 2010/0184939 A1
(43) Pub. Date: Jul. 22, 2010

(54) METHOD FOR PRODUCING BI-AXIALLY ORIENTED THERMOPLASTIC RESIN FILM, AND BASE FILM FOR OPTICAL FILM

(75) Inventors: Masaaki Otoshi, Kanagawa (JP); Shinichi Nakai, Kanagawa (JP); Yasuyuki Maki, Kanagawa (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/602,031

(22) PCT Filed: May 22, 2008
(86) PCT No.: PCT/JP2008/059423

§ 371 Date: Nov. 25, 2009

(30) Foreign Application Priority Data
May 25, 2007 (JP) 2007-139471

(51) Int. Cl. C08G 63/183; B29C 55/14

(52) U.S. Cl. 528/308.1; 264/210.7

(57) ABSTRACT

In the method for producing a bi-axially oriented thermoplastic resin film, the longitudinal draw ratio X in a longitudinal drawing step is in the range of from 2.8 times to 3.5 times, and the transverse draw ratio Y in a transverse drawing step is in the range of from 3.8 times to 4.8 times. The expression: X≧0.25Y+2.0+(T−(Tg+50))/400, is satisfied where T° C. represents the temperature of the thermoplastic resin film in the transverse drawing step in a tenter 28 and Tg° C. represents the glass transition temperature of the thermoplastic resin film.

### TECHNICAL FIELD

The present invention relates to a method for producing a bi-axially oriented thermoplastic resin film, and an optical film, and particularly relates to a method for producing a polyester film which is suitably used for various optical members used in liquid crystal displays (LDC), plasma displays (PDP) and the like and for protective films, release films and the like used in production processes of products in the optical field, and to a base film for an optical film.

### BACKGROUND ART

Polyester films, particularly, bi-axially oriented films of polyethylene terephthalate and polyethylene naphthalate, are conventionally known to have excellent mechanical properties, heat resistance and chemical resistance, and are broadly used as materials for magnetic tapes, ferromagnetic thin tapes, photographic films, packaging films, films for electronic members, electric insulating films, films for metal laminates, films attached to glass surfaces such as glass display films, protective films for various members and the like.

Recently, polyester films have often been used particularly for various types of optical films, and are used for the various types of applications including base films for prism sheets, light diffusion sheets, reflectors, touch panels and the like as members of LCD, antireflection base films, base films for explosion-proof displays, and films for PDP filters. In such optical products, in order to provide bright and clear images, base films used as optical films need to have good transparency and be free from foreign matter and defects such as scratches affecting images because of the way the base films are used. In addition thereto, particularly, even in the case of using polarization of light, the base films need to exhibit no polarization unevenness caused by orientation unevenness and thickness unevenness of the polymers.

In production of optical films of such types, a bi-axially oriented polyester film used as a base film for an optical film has conventionally been produced by casting a melted thermoplastic resin discharged from a die on a cooling drum to quench and solidify the resin to obtain a film, longitudinally drawing the obtained film by a heating draw roller and a cooling draw roller having different peripheral speeds, and thereafter transversely drawing the longitudinally drawn film in a tenter whose temperature is held at a predetermined one (see Patent Document 1).

### Patent Document 1: Japanese Patent Application Laid-Open No. 2000-263642

### DISCLOSURE OF THE INVENTION

### Problems to be Solved by the Invention

However, when a melted thermoplastic resin is cast on a cooling drum from a die to form an unoriented film, the obtained film is liable to generate thickness unevenness in the width direction, and the thickness unevenness causes polarization unevenness in an optical film. Particularly in the case of a thick film, since uniform cooling becomes difficult, thickness unevenness in the width direction is liable to be generated.

In order to improve the thickness unevenness in the width direction generated during the film formation, there is a method in which the longitudinal draw ratio is made low in the drawing step of the post-stage of the film forming step, and the transverse draw ratio in a tenter is made high, but there arises a problem that the high transverse draw ratio brings about easy breaking of the film. Hence, the real situation is that the thickness unevenness in the width direction generated during the film formation cannot sufficiently be improved in the drawing step.

Therefore, if the breaking of the film is prevented in transverse drawing even at a high transverse draw ratio, the thickness unevenness in the width direction generated during the film formation can sufficiently be improved in the drawing step.

The present invention has been achieved in consideration of such a situation, and an object thereof is to prevent the braking of the film in the drawing step after the film forming step even when the longitudinal draw ratio is made low and the transverse draw ratio is made high in order to improve the thickness unevenness in the width direction generated during the film formation, and thus to provide a method for producing a bi-axially oriented thermoplastic resin film, the method being capable of making the thickness of an obtained film uniform and producing a high-quality film having no polarization unevenness, and a base film for an optical film produced by the production method.

### Means for Solving the Problems

In order to achieve the above-mentioned object, a method for producing a bi-axially oriented thermoplastic resin film according to a first aspect of the present invention comprises the film forming step for extruding a melted thermoplastic resin from a die and casting the melted thermoplastic resin on a cooling drum to form a film, the longitudinal drawing step for longitudinally drawing the unoriented thermoplastic resin film thus formed, and the transverse drawing step for transversely drawing the longitudinally drawn thermoplastic resin film in a tenter, wherein the longitudinal draw ratio X in the longitudinal drawing step is in the range of from 2.8 times to 3.5 times, and the transverse draw ratio Y in the transverse drawing step is in the range of from 3.8 times to 4.8 times; and the expression: X≧0.25Y+2.0+(T−(Tg+50))/400, is satisfied where T° C. represents the temperature of the thermoplastic resin film in the transverse drawing step in the tenter and Tg° C. represents the glass transition temperature of the thermoplastic resin film.

According to the production method according to the first aspect, since the longitudinal draw ratio X in the longitudinal drawing step is made to be 2.8 times or more and 3.5 times or less, and the transverse draw ratio Y in the transverse drawing step is made to be 3.8 times or more and 4.8 times or less, the thickness unevenness in the width direction generated during the film formation can sufficiently be improved in the drawing steps. Further, since as conditions of the transverse drawing in the tenter is designed so that the relation among specified values (pinpoint numerical values) of the longitudinal draw ratio and transverse draw ratio satisfying the ranges of the above-mentioned longitudinal draw ratio and transverse draw ratio, the film temperature in the tenter and the film glass transition temperature satisfies the above-mentioned expression, the film is not broken even if the transverse draw ratio is made high. This is supposedly because the satisfaction of the expression suppresses excessive progress of crystallization during the transverse drawing and prevents the film breaking. Hence, since the thermoplastic resin film is not broken even if the draw ratio during the transverse drawing is made high, a bi-axially oriented thermoplastic resin film can be produced which has no polarization unevenness caused by the thickness unevenness in the width direction and has good optical characteristics.

According to a second aspect of the present invention, in the production method of a bi-axially oriented thermoplastic resin film according to the first aspect, the thermoplastic resin film is a polyester film.

The second aspect is an application of the first aspect to a polyester used as an optical film. Thereby, a bi-axially oriented polyester film having good optical characteristics can be produced.

According to a third aspect of the present invention, in a production method of a bi-axially oriented thermoplastic resin film according to the first or second aspect, the thickness before drawing of the thermoplastic resin film is 1,400 μm or more and 4,000 μm or less.

When a thermoplastic resin film having a relatively large thickness of 1,400 μm or more and 4,000 μm or less before drawing is produced, uniform cooling by the cooling drum is difficult and thickness unevenness in the width direction of the obtained film is liable to be generated. However, according to the third aspect, even in such a case, the thickness unevenness can be improved without breaking of the film in the drawing steps.

According to a fourth aspect of the present invention, a base film for an optical film is produced by a production method of a bi-axially oriented thermoplastic resin film according to any one of the first to third aspects.

Thereby, a base film for an optical film free of optical defects and polarization unevenness and having excellent optical properties can be provided.

### ADVANTAGES OF THE INVENTION

The aspects of the present invention can provide a method for producing a bi-axially oriented thermoplastic resin film, the method being capable to uniformize a thickness of the obtained film and can produce a high-quality film having no polarization unevenness. Further, the aspects of the present invention can provide a high-quality base film for an optical film.

### BRIEF DESCRIPTION OF THE DRAWINGS

FIG. 1 is a diagram showing an outline of a production apparatus of a polyester film;

FIG. 2 is an illustrative diagram showing a positional relation between a die and a cooling drum describing the definition of an angle α;

FIG. 3 is a schematic diagram of a transverse drawing machine carrying out a transverse drawing step; and

FIG. 4 is a table showing conditions of drawing steps and their evaluation results in Examples and Comparative Examples.

### DESCRIPTION OF SYMBOLS

10 . . . Film forming step section
12 . . . Longitudinal drawing step section
14 . . . Polyester film
16 . . . Transverse drawing step section
18 . . . Winding step section
20 . . . Die
22 . . . Cooling drum
24, 26 . . . Nip roller
28 . . . Tenter
30 . . . Wind shielding curtain

### BEST MODE FOR CARRYING OUT THE INVENTION

Hereinafter, preferable embodiments of a method for producing a bi-axially oriented thermoplastic resin film and a base film for an optical film will be described in connection with accompanying drawings.

In the embodiments, a production of a polyester film as an example of thermoplastic resins will be described, but the present invention is not limited thereto and is adaptable also to a production apparatus and a production method of thermoplastic resin films such as polycarbonate resin films and saturated norbornene resin films.

Polyesters used in the present embodiments are polymers obtained by polycondensation of a diol and a dicarboxylic acid. Dicarboxylic acids are represented by terephthalic acid, isophthalic acid, phthalic acid, naphthalene dicarboxylic acid, adipic acid, sebacic acid and the like; and diols are represented by ethylene glycol, triethylene glycol, tetramethylene glycol, cyclohexane dimethanol and the like. The polyesters specifically include, for example, polyethylene terephthalate, polytetramethylene terephthalate, polyethylene-p-oxybenzoate, poly-1,4-cyclohexylene dimethylene terephthalate and polyethylene-2,6-naphthalene dicarboxylate. These polyesters may be homopolymers, copolymers with a monomer of a different component, or blended materials. The copolymerization components include, for example, diol components such as diethylene glycol, neopentyl glycol and polyalkylene glycol, and carboxylic acid components such as adipic acid, sebacic acid, phthalic acid, isophthalic acid and 2,6-naphthalene dicarboxylic acid.

For the esterification reaction and the transesterification reaction in production of the above-mentioned polyesters, well-known corresponding catalysts can be used. The esterification reaction progresses even with no special addition of a catalyst, but with no addition of a catalyst, a polymer must be held at a high temperature for a long time since the esterification reaction takes much time, resulting in disadvantages including causing thermal degradation. Then, addition of a catalyst as described below can efficiently progress the transesterification reaction.

For example, catalysts for the esterification reaction to be usable are not especially limited, but include manganese acetate, manganese acetate tetrahydrate, cobalt acetate, magnesium acetate, magnesium acetate tetrahydrate, calcium acetate, cadmium acetate, zinc acetate, zinc acetate dehydrate, lead acetate, magnesium oxide and lead oxide. These may be used singly or as a mixture thereof.

In the embodiment, the specific resistance of a melted and extruded polyester resin is regulated to be 5×10⁶ to 3×10⁸ Ω·cm. The reason is that the specific resistance of less than 5×10⁶ Ω·cm increases a yellowish tinge and generates much foreign matter; and by contrast, the specific resistance exceeding 3×10⁸ Ω·cm entrains a large amount of air and generates irregularities on the film surface.

In order to regulate the specific resistance of the polyester resin, the content of the metal catalyst is regulated. Generally, the higher content of the metal catalyst in a polymer progresses more rapidly the transesterification reaction and gives a smaller specific resistance, but a too much content of the metal catalyst cannot be homogeneously dissolved in the polymer and causes aggregated foreign matter to be generated. In the present invention, the specific resistance of a polyester resin is regulated in a predetermined range by regulation of the content of the metal catalyst.

The polyester resins may contain phosphoric acid, phosphorous acid and an ester thereof, and an inorganic particle (silica, kaolin, calcium carbonate, titanium dioxide, barium sulfate, alumina and the like) in the polymerization stage, or may be blended with an inorganic particle and the like after the polymerization. The polyester resins may be added further with well-known substances such as thermal stabilizers, antioxidants, antistatic agents, lubricants, ultraviolet absorbents, fluorescent brightening agents, pigments, light shielding agents, fillers and flame retardants.

In the embodiment, a case of production of a base film for an optical film using the above-mentioned polyester resin will be described as an example.

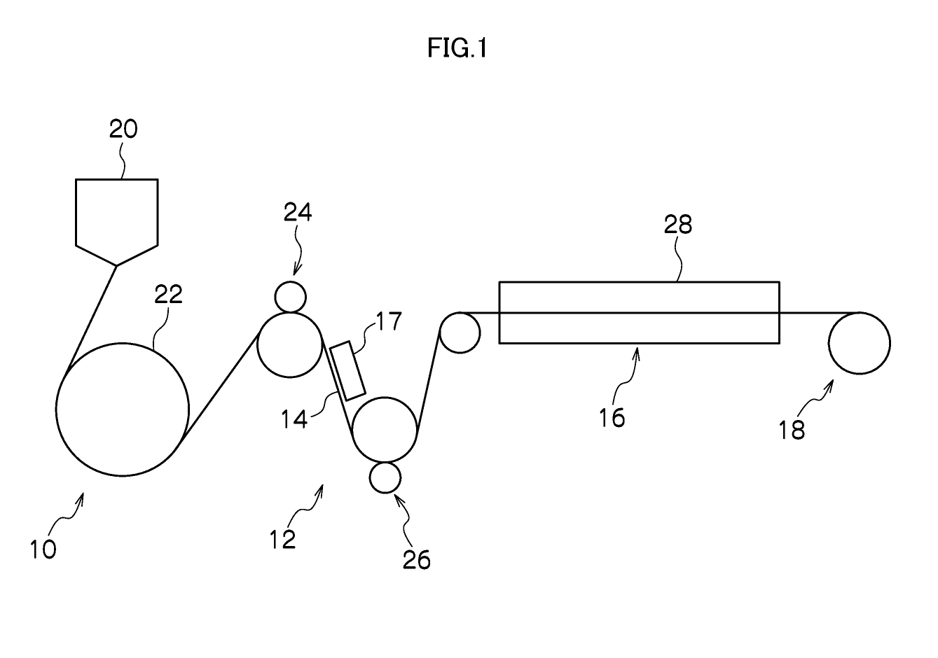

FIG. 1 is a diagram showing an outline of a production apparatus of a polyester film. In the figure, reference numeral 10 designates a film forming step section for casting film-formation of a polyester film; reference numeral 12 designates a longitudinal drawing step section for longitudinally drawing the polyester film 14 formed in the film forming step section 10; reference numeral 16 designates a transverse drawing step section for transversely drawing the polyester film 14 longitudinally drawn in the longitudinal drawing step section 12; and reference numeral 18 designates a winding step section for winding up the polyester film 14 drawn in the transverse drawing step section 16.

First, the film forming step section 10 will be described. The polyester resin is fully dried, then melted and extruded in a sheet form through an extruder (not shown in figure) whose temperature is controlled to be, for example, higher than a melting point of the polyester resin by 10° C. or more and 50° C. or less, a filter (not shown in figure) and a die 20, and casted on a rotating cooling drum 22 to obtain a quenched and solidified film.

In such a film forming step section 10, thickness unevenness is sometimes generated in the width direction of a formed polyester film 14. Particularly in the case of forming a thick polyester film 14, thickness unevenness is liable to be generated because the adjustment of the thickness by a lip clearance adjusting bolt of the die 20 is difficult. Since such thickness unevenness causes polarization unevenness in optical characteristics of a base film for an optical film, the thickness unevenness needs to be improved in the drawing step sections (the longitudinal drawing step section 12 and the transverse drawing step section 16) after the film formation.

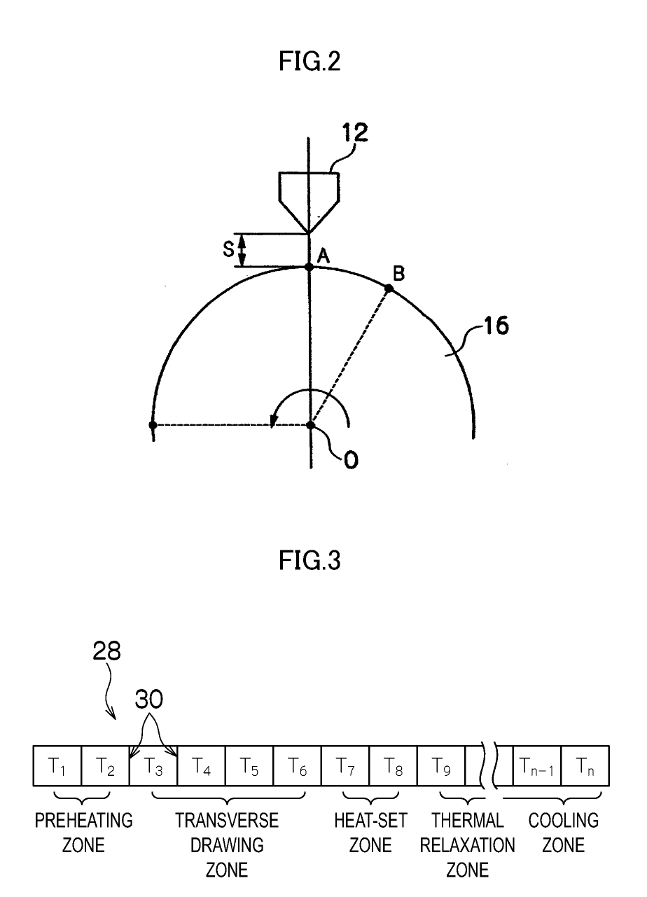

There is sometimes generated thickness unevenness in the flowing direction as well as the thickness unevenness in the width direction in the film forming step section 10, and in order to control this unevenness, the positional relation between the die 20 and the cooling drum 22 is preferably established as follows. Specifically, as shown in FIG. 2, if a line connecting the rotation axis O of the cooling drum 16 and the point A on the peripheral surface of the cooling drum right above the rotation axis O is assumed as an angle of 0°, the die 12 is preferably arranged in a region ranging from a position B at an angle of −20° to a position C at an angle of +90°, and more preferably a region ranging from a position at an angle of −10° to a position at an angle of +45°. If the position where the die 12 is arranged in a region on a negative side beyond the position at the angle of −20°, the film surface is liable to generate transverse step-like unevenness and longitudinal streaks. Here, the arrangement position of the die 12 cannot naturally become a position at an angle larger than 90°.

An air gap S of a distance from the front end of the die 20 to the peripheral surface of the cooling drum 22 is preferably 20 mm or more and 300 mm or less, and more preferably 40 mm or more and 140 mm or less. The air gap S of less than 20 mm is liable to generate transverse step-like unevenness and longitudinal streaks on the film surface. By contrast, the air gap S exceeding 300 mm causes film swing and generates thickness unevenness.

In order to further suppress the thickness unevenness in the width direction in the film forming step section 10, to the melted resin discharged in a sheet form from the die 20 installed in the above-mentioned positional relation with the cooling drum 22, a high voltage of 10 kV or higher and 30 kV or lower is preferably applied by an electrostatic application apparatus such as a wire pinning apparatus not shown in figure arranged in the vicinity of the cooling drum 22. This voltage application can raise the adhesion between the resin sheet discharged from the die 20 and the cooling drum 22, and provide a quenched and solidified, unoriented polyester film.

The unoriented polyester film thus obtained is fed to the longitudinal drawing step section 12 to be longitudinally drawn.

In the longitudinal drawing step section 12, the polyester film 14 is preheated, and then mounted on two nip rollers composed of a heating draw nip roller 24 and a cooling draw nip roller 26. The cooling draw nip roller 26 located on the outlet side conveys the polyester film 14 at a conveyance speed higher than that of the heating draw nip roller 24 located on the inlet side. Thereby, the polyester film 14 is longitudinally drawn. An infrared ray heater 17 is installed in the vicinity of the heating draw nip roller 24 to heat the polyester film 14 being drawn. The spacing distance between the heating draw nip roller 24 and the far-infrared ray heater 17 is preferably in the range of 5 to 40 mm. The heating temperature is preferably Tg to Tg+30° C., and more preferably Tg+5° C. to Tg+20° C.

In the longitudinal drawing step section 12, the distance between the draw nip rollers 24 and 26 is 30 mm or more and 1,000 mm or less, and preferably 100 mm or more and 400 mm or less. In the case of the distance between the draw nip rollers 24 and 26 being less than 30 mm, the production stability is low because a narrow heating range by the heater is liable to bring about insufficient heating. By contrast, in the case of the distance between the draw nip rollers 24 and 26 exceeding 1,000 mm, the distance of the polyester film which is not in contact with the draw nip rollers 24 and 26 becomes long and the thickness of ear portions (both ends in the width direction) thereof becomes too large due to an increase in the neck-in amount during drawing, bringing about draw unevenness.

In the embodiment, in the longitudinal drawing step section 12, the longitudinal drawing is carried out in a manner that the longitudinal draw ratio X becomes 2.8 times or more and 3.5 times or less, that is, the longitudinal draw ratio becomes lower than the transverse draw ratio Y in the next transverse drawing step section 16.

The longitudinally drawn polyester film longitudinally drawn at the specific draw ratio as described above is conveyed to the transverse drawing step section 16 to be transversely drawn.

The transverse drawing step section 16 carries out a step in which the longitudinally drawn polyester film is transversely drawn by applying a tensile force in the width direction of the film while the film is being heated, and uses a tenter 28 as a transverse drawing machine. As shown in FIG. 3, the tenter 28 includes a large number of zones, whose temperatures can be independently controlled by hot air or the like, divided by wind shielding curtains 30, and preferably has an arrangement of, from the inlet, preheating zones T₁ and T₂, transverse drawing zones T₃, T₄, T₅ and T₆, heat-set zones T₇ and T₈, thermal relaxation zones T₉ to Tₙ₋₃, and cooling zones Tₙ₋₂ to Tₙ. The thermal relaxation zones T₉ to Tₙ₋₃ and the cooling zones Tₙ₋₂ to Tₙ are not always needed, and may be installed according to needs.

Then, in the embodiment, in the transverse drawing zone T₆ which has a highest temperature out of the transverse drawing zones T₃, T₄, T₅ and T₆ in the tenter 28, the longitudinally drawn polyester film is transversely drawn in a manner that the following conditions are satisfied. That is, the transverse draw ratio Y is in the range of from 3.8 times to 4.8 times; and the following expression (1) is satisfied where T° C. represents the temperature of the polyester film in the tenter 28 and Tg° C. represents the glass transition temperature of the polyester film.

X≧0.25Y+2.0+(T−(Tg+50))/400 (1)

In such a way, in the longitudinal drawing step section 12 described above, the longitudinal draw ratio X is set to be low and in a range from 2.8 times or more to 3.5 times or less; the transverse draw ratio Y in the transverse drawing step section 16 is set to be high and in a range from 3.8 times or more to 4.8 times or less; thereby, the thickness unevenness in the film width direction generated in the film forming step section 10 can effectively be improved.

Additionally, in the transverse drawing step section 16, since the expression (1) shown above is designed to be satisfied, the polyester film 14 is unlikely to be broken during the transverse drawing because generation and growth of crystals in the film can be suppressed even if the transverse draw ratio of the film 14 is made as high as in the range described above. Hence, in the transverse drawing step section 16, since the thickness unevenness in the film width direction generated in the film forming step section 10 can effectively be improved without breaking the film 14, a bi-axially oriented polyester film having good optical characteristics can be produced.

Thus, a bi-axially oriented polyester film more useful as a base film for an optical film can be provided. The bi-axially oriented polyester film thus obtained is wound up on a winding step section 18.

### EXAMPLES

As to Examples satisfying the conditions in the production method according to the embodiment and Comparative Examples not satisfying those, using the production apparatus of a polyester film shown in FIG. 1, the presence/absence of the breaking in the transverse drawing step was evaluated and the uniformity of the thickness of the film after the transverse drawing step was also evaluated.

In the tests, a polyester film (cellulose acylate film) of 2,500 μm in thickness was formed in the film forming step in Examples and also Comparative Examples. In Examples, the polyester films were subjected continuously to the longitudinal drawing step and to the transverse drawing step under the conditions conforming to the embodiment. In Comparative Examples, the polyester films were subjected continuously to the longitudinal drawing step and to the transverse drawing step under the conditions not conforming to the embodiment.

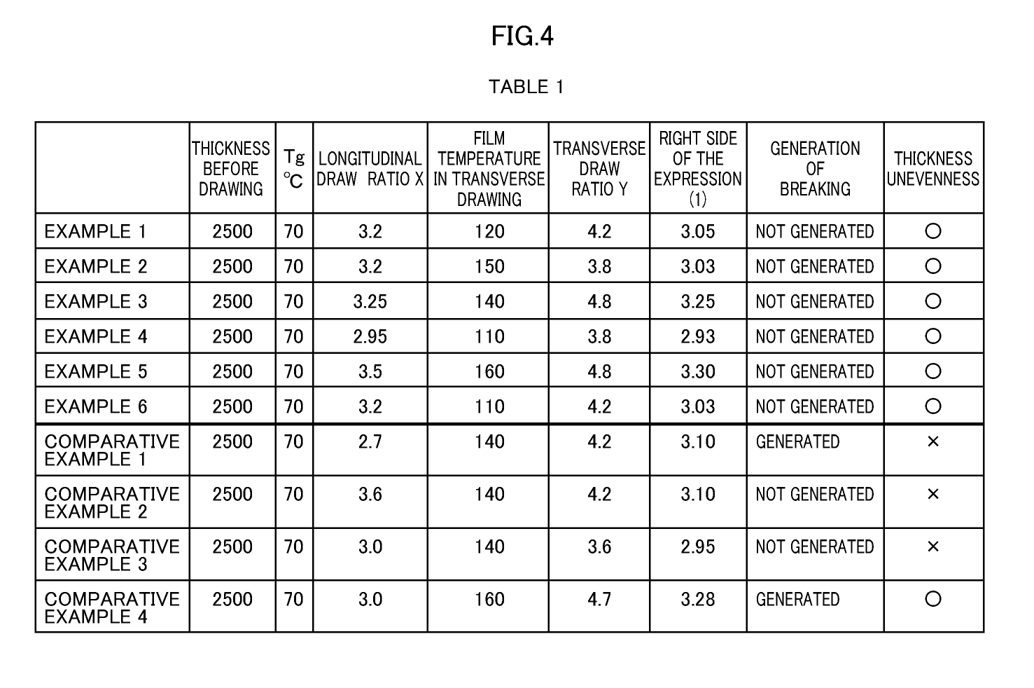

Table 1 shown in FIG. 4 shows the conditions in Examples (1 to 6) and Comparative Examples (1 to 4) and the evaluation results on “film breaking property” and “uniformity of film thickness”. In “uniformity of film thickness” of the evaluation results, the mark ◯ indicates that a film has a uniformity which can be used as an optical film; and the mark [symbol] indicates that a film cannot be used as an optical film.

The conditions satisfying the production method according to the embodiment are as follows (a) to (c).

(a) The longitudinal draw ratio X in the longitudinal drawing step is in the range of 2.8 to 3.5.
(b) The longitudinal draw ratio X in the transverse drawing step is in the range of 3.8 to 4.8.
(c) The expression: X≧0.25Y+2.0+(T−(Tg+50))/400, is satisfied where T° C. represents the temperature of the polyester film in the tenter and Tg° C. represents the glass transition temperature of the polyester film. Here, whether or not (c) is satisfied is clarified by comparison of the longitudinal draw ratio X in Table 1 and a numerical value obtained by calculation of the right side of the expression (1) in Table 1.

Examples 1 to 6 in Table 1 were cases satisfying all of (a) to (c) described above. Example 4 was a case where the longitudinal draw ratio X and the transverse draw ratio Y were a ratio near the lower limit and a ratio of the lower limit, respectively. Example 5 was a case where those were a ratio near the upper limit and a ratio of the upper limit, respectively. Example 3 was a case where the longitudinal draw ratio X and the right side of the expression (1) in Table 1 were equal.

Comparative Example 1 was a case having the lower limit of (a) of the conditions described above and not satisfying (c); and Comparative Example 2 was a case not satisfying the upper limit of (a). Comparative Example 3 was a case not satisfying the lower limit of (b); and Comparative Example 4 was a case not satisfying (c).

As is clear from the results in Table 1, satisfaction of all of the conditions (a) to (c) according to the embodiment exhibited no breaking in the transverse drawing step, and could produce a polyester film having a uniform thickness.

By contrast, Comparative Examples 1 to 4, which did not satisfy at least one of the conditions (a) to (c) according to the embodiment, gave results having a problem with both of or either one of “film breaking property” and “uniformity of film thickness”.

Thus, the embodiment can uniformize the thickness of the obtained film, and materialize a method for producing a bi-axially oriented thermoplastic resin film, which can produce a high-quality film having no polarization unevenness, and a high-quality base film for an optical film.

The embodiments have been described heretofore, but the present invention is not limited to the embodiments, and various changes and modifications may be made.

1. A method for producing a bi-axially oriented thermoplastic resin film, comprising:
the film forming step for extruding a melted thermoplastic resin from a die and casting the melted thermoplastic resin on a cooling drum to form a film;
the longitudinal drawing step for longitudinally drawing the unoriented thermoplastic resin film thus formed; and
the transverse drawing step for transversely drawing the longitudinally oriented thermoplastic resin film in a tenter,
wherein the longitudinal draw ratio X in the longitudinal drawing step is in the range of from 2.8 times to 3.5 times, and the transverse draw ratio Y in the transverse drawing step is in the range of from 3.8 times to 4.8 times; and
the expression:
X≧0.25Y+2.0+(T−(Tg+50))/400
is satisfied, where T° C. represents the temperature of the thermoplastic resin film in the transverse drawing step in the tenter and Tg° C. represents the glass transition temperature of the thermoplastic resin film.

2. The method for producing a bi-axially oriented thermoplastic resin film according to claim 1,
wherein the thermoplastic resin film is a polyester film.

3. The method for producing a bi-axially oriented thermoplastic resin film according to claim 1,
wherein the thermoplastic resin film before the drawing has a thickness of 1,400 μm or more and 4,000 μm or less.

4. A base film for an optical film, which is produced by a method for producing a bi-axially oriented thermoplastic resin film according to claim 1.

5. The method for producing a bi-axially oriented thermoplastic resin film according to claim 2,
wherein the thermoplastic resin film before the drawing has a thickness of 1,400 μm or more and 4,000 μm or less.

6. A base film for an optical film, which is produced by a method for producing a bi-axially oriented thermoplastic resin film according to claim 2.
